(19) United States
(12) Patent Application Publication
(10) Pub. No.: US 2010/0051554 A1
(43) Pub. Date: Mar. 4, 2010

(54) MOLECULAR BASKET COATED MICRO PARTICLES

(76) Inventor: Dong June Ahn, Seoul (KR)

Correspondence Address: EDWARDS ANGELL PALMER & DODGE LLP, P.O. BOX 55874, BOSTON, MA, 02205, US

(21) Appl. No.: 12/200,357

(22) Filed: Aug. 28, 2008

(51) Int. Cl. B01D 15/08; B01J 20/00; B01J 20/285; B01J 20/10; B01J 20/20; B01J 20/283

(52) U.S. Cl. 210/656; 210/198.2; 502/400; 502/402; 502/407; 502/416; 502/401

(57) ABSTRACT

Micro particulate compositions include molecular baskets deposited on the surface and impregnated within pores of micro particles. They may be used to detect and/or separate a target material in a sample. Molecular baskets include a molecular framework defining an exterior region and an interior target receiving region. Micro particles may have a high total surface area provided by external surfaces and internal pore surfaces. Micro particulate compositions are manufactured by dispersing molecular baskets onto outer surfaces and within internal pores of porous microparticles (e.g., as a solution or suspension within a solvent). Analytical devices for detection and/or separation of target materials in samples include a micro particulate composition configured to facilitate contact between the micro particulate composition and a sample.

### CROSS-REFERENCE TO RELATED APPLICATION

None.

### BACKGROUND

1. Technical Field

The disclosed technology relates to micro particulate compositions and methods which may be used for detection or separation.

2. Background Technology

Chromatographic techniques of various forms are widely used to separate mixtures of materials into two or more different components or submixtures. Chromatography typically involves passing a mixture in a mobile phase through a stationary phase, which separates the analyte to be measured from other molecules in the mixture and allows it to be isolated. Chromatography may be preparative or analytical. Preparative chromatography seeks to separate the components of a mixture for further use and is thus a form of purification. Analytical chromatography normally operates with smaller amounts of material and seeks to measure the relative proportions of analytes in a mixture.

Examples of separation techniques include column chromatography, flash column chromatography, expanded bed adsorption, high performance liquid chromatography, gas chromatography, affinity chromatography, paper chromatography, supercritical fluid chromatography, ion exchange chromatography, size exclusion chromatography, countercurrent chromatography, chiral chromatography, thin layer chromatography, planar chromatography, and partition chromatography.

By way of example, column chromatography utilizes a stationary bed within a tube. Particles in a solid stationary phase, or a support coated with a liquid stationary phase, may fill the entire inside volume of the tube to form a packed column. Alternatively, they may be concentrated on or along the inside tube wall leaving an open, unrestricted path for the mobile phase in the middle part of the tube to form an open tubular column. The components of a mixture are separated due to different retention rates within the column. A modified version of column chromatography is flash column chromatography, which is similar to traditional column chromatography, except the solvent is driven through the column by applying a positive pressure. In gas chromatography, the mobile or fluid phase is a gas rather than a liquid. Gas chromatography is typically used in analytic methods.

Molecular sieves are another medium used to separate mixtures of materials. Molecular sieves contain tiny pores of precise and uniform size and are used as an adsorbent for gases and liquids. Molecules small enough to pass through the pores are adsorbed while larger molecules are excluded. Molecular sieves differ from common filters in that they operate on a molecular level. For example, a water molecule may be small enough to pass through while larger molecules are not. Because of this, they often function as a desiccant. Molecular sieves typically consist of aluminosilicate minerals, clays, porous glasses, microporous charcoals, zeolites, active carbons, or synthetic compounds that have open structures through which small molecules, such as nitrogen and water can diffuse.

In general, accurate detection and/or separation of target materials out of any mixture components are often necessary or desirable for chemical sensing. In addition, detection and/or separation yields need to be higher for high-throughput processing.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Embodiments of the disclosure include micro particulate compositions, methods for manufacturing micro particulate compositions, and methods and apparatus that utilize such compositions. The micro particulate compositions generally include molecular baskets deposited on the surface and impregnated within pores of micro particles. The micro particulate compositions may be used to detect and/or separate a target material in a sample. The micro particulate compositions can provide improved detection and/or separation yields for high-throughput processing.

According to one embodiment a micro particulate composition includes molecular baskets dispersed onto and impregnated within porous micro particles. The molecular baskets each include a molecular framework defining an exterior region and an interior target receiving region. The interior target receiving region has a physical structure and/or chemical functionality adapted for selectively receiving and binding a corresponding target material. Examples of molecular baskets include, but are not limited to, calixarenes, crown ethers, and glycoluril-based host molecules. Exemplary micro particles include, but are not limited to, glass, silica, latex, polystyrene, carbon, silver, copper, and metal micro particles. They may have a high total surface area provided by external surfaces and internal pore surfaces.

In another embodiment a micro particulate composition is manufactured by dispersing molecular baskets onto outer surfaces and within internal pores of porous microparticles. The molecular baskets may be provided and dispersed in the form of a solution or suspension within a solvent.

In yet another embodiment an analytical device for detection and/or separation of a target material in a sample includes a micro particulate composition configured so as to facilitate contact between the micro particulate composition and a sample to be analyzed. The analytical device may include a micro particulate composition at least partially contained within a vessel, such as a column, a tube, a probe, a reactor, or a membrane.

In still another embodiment a micro particulate composition is used to detect and/or separate a target material in a sample. This method includes exposing the micro particulate composition to a sample containing a target material, wherein the micro particulate composition selectively binds to the target material. In the case of separation, it may be desirable to apply a stimulus and cause the molecular baskets to release the target material for further analysis or other processing.

The contents of this summary are only provided as a simplified introduction and are not to be used to interpret or limit the scope of the claims. Additional features and advantages will be set forth in the description that follows, and in part will be obvious from the description, or may be learned by the practice of the disclosed embodiments.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings, in which:

FIG. 1 schematically illustrates a molecular basket and a target materials associated with the molecular basket; and

FIG. 2 schematically illustrates a micro particulate composition that includes molecular baskets on a surface and within pores of a micro particle.

### DETAILED DESCRIPTION OF EXEMPLARY EMBODIMENTS

The illustrative embodiments described in the detailed description and claims are not meant to be limiting. Other embodiments may be utilized, and other changes may be made, without departing from the spirit or scope of the subject matter presented here.

### I. Introduction

Exemplary embodiments include micro particulate compositions, methods for manufacturing micro particulate compositions, and methods and apparatus that utilize such compositions.

“Molecular baskets” are a class of molecular materials that function as pockets which can recognize specific targets out of mixed samples. Molecular baskets generally include a molecular framework defining an exterior region and an interior target receiving region. The interior target receiving region of the molecular basket may have a physical structure and/or chemical functionality adapted to selectively receive and bind a target material.

“Micro particles” are micron-scale particles which can have a high surface area, e.g., as a result of outer surfaces and internal porosity. Micro particles offer surfaces for attachment and immobilization of molecular baskets both on the external surface of the micro particles as well as within the internal pore surfaces. Micro particles permit molecular baskets to be immobilized and therefore utilized as a solid material while providing a relatively high concentration or number of molecular baskets within a given volume compared to conventional immobilization techniques using conventional solid support structures. By providing a high surface area for attachment of molecular baskets, micro particles can increase the performance yield of analytical and/or separation methods utilizing molecular baskets compared to conventional methods.

“Micro particulate compositions” include molecular baskets deposited onto and within porous micro particles. Micro particulate compositions may be used to detect and/or separate target materials in samples. They can provide improved detection and/or separation yields for high-throughput processing.

“Analytical devices” may include micro particulate compositions configured so as to facilitate contact between the micro particulate composition and a sample containing a target material. The micro particulate composition may be at least partially contained within a vessel, such as a column, a tube, a probe, a reactor, or a membrane.

### II. Micro Particulate Compositions

Any known type of molecular basket can be immobilized on the surface and within the pores of micro particles to yield micro particulate compositions according to this disclosure. According to one embodiment a micro particulate composition includes molecular baskets dispersed onto and impregnated within porous micro particles. Each molecular basket includes a molecular framework defining an exterior region and an interior target receiving region. The interior target receiving region has a physical structure and/or chemical functionality adapted for selectively receiving and binding a corresponding target material.

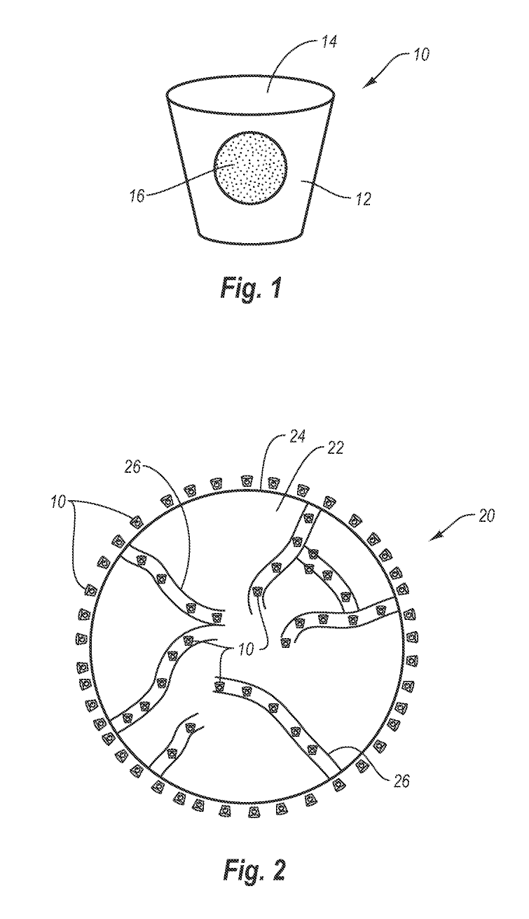

FIG. 1 schematically illustrates an exemplary molecular basket 10 having a molecular framework 12 defining an exterior region and an interior target region 14. Disposed at least partially within the interior target region 14 is a target 16 (e.g., a molecule, complex, atom or ion).

FIG. 2 schematically illustrates an exemplary micro particulate composition 20 which includes a micro particle 22 having an exterior surface 24 and internal pores 26 and molecular baskets 10 disposed on the exterior surface 24 and also within the internal pores 26 of the micro particle 22. The molecular baskets 10 are illustrated with targets 16 disposed within the interior target region 14 (FIG. 1). It will be appreciated that the micro particulate composition 20 may or may not include targets 16 depending on whether they are analyzed or considered before or after selective bonding of the molecular baskets 10 with the targets 16.

Examples of molecular baskets include, but are not limited to, calixarenes, crown ethers, and glycoluril-based host molecules. Molecular baskets may capture target materials by chemical affinity and/or size exclusion and/or shape recognition. Examples of target materials that can be selectively captured by molecular baskets include CO2, other gases such as volatile organic compounds, noble gases and other elemental gases, metal ions such as coordinated metal ions, ions or ground state atoms of alkali metals, alkaline earth metals, transition metals, rare earth metals, noble metals, and non-metals. Virtually any molecule or atom is potentially a target of a corresponding molecular basket.

Any known type of micro particle can be used to immobilize molecular baskets according to this disclosure. Non-limiting examples of micro particles include micro particles which comprise at least one of glass, silica, latex, polystyrene, carbon, silver, copper, other metal, or magnetic material. According to one embodiment, the micro particles may have a size in a range of about 0.1 micron to about 1000 microns, or in a range of about 0.25 micron to about 500 microns, or in a range about 0.5 micron to about 250 microns, or in a range of about 1 micron to about 100 micros.

The porous micro particles may have a high total surface area provided by external surfaces and internal pore surfaces. According to one embodiment, the specific surface area of exemplary micro particles used to immobilize the molecular baskets is in a range of about 1 m²/kg to about 5,000,000 m²/kg. According to another embodiment, the specific surface area of the micro particles is in a range of about 10 m²/kg to about 500,000 m²/kg. According to yet another embodiment, the specific surface area of the microparticles is in a range of about 100 m²/kg to about 50,000 m²/kg.

According to one embodiment, the concentration of molecular baskets within the micro particulate composition is in a range of about 1 pg/cm³ to about 1 g/cm³, expressed in terms of mass of molecular baskets per unit volume of the micro particulate composition. In another embodiment, the concentration of molecular baskets within the micro particulate composition is in a range of about 100 ng/cm³ to about 100 μg/cm³. In yet another embodiment, the concentration of molecular baskets within the micro particulate composition is in a range of about 1 ng/cm³ to about 1 μg/cm³.

In terms of concentration by weight, the molecular baskets can have a concentration in a range of about 0.000001% to about 30% by weight of the micro particulate composition, or about 0.0001% to about 10% by weight, or about 0.01% to about 1% by weight.

A. Examples of Molecular Baskets

1. Calixarenes

One class of exemplary molecular baskets is known as calixarenes. A calixarene is a macrocycle or cyclic oligomer based on a hydroxyalkylation product of a phenol and an aldehyde. The word “calixarene” is derived from calix or chalice because this type of molecule resembles a vase and from the word arene that refers to the aromatic building block. Calixarenes have hydrophobic cavities that can hold smaller molecules or ions and belong to the class of cavitands known in Host-guest chemistry. Calixarene nomenclature is straightforward and involves counting the number of repeating units in the ring and including it in the name. A “calix[4]arene” has 4 units in the ring and a “calix[6]arene” has 6. A substituent in the meso position Rb is added to the name with a prefix C- as in C-methylcalix[6]arene.

The aromatic components in calixarenes may be derived from phenol, resorcinol or pyrogallol to yield compounds having the following generic structures:

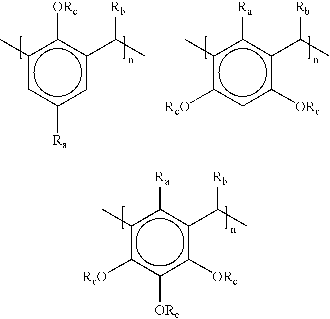

For phenol, the aldehyde most often used is simply formaldehyde, while larger aldehydes (acetaldehyde, or larger) are generally required in condensation reactions with resorcinol and pyrogallol. The chemical reaction ranks under electrophilic aromatic substitutions followed by an elimination of water and then a second aromatic substitution. The reaction is acid or base catalyzed. A pyrogallol[4]arene can be produced by simply mixing a solvent-free dispersion of isovaleraldehyde with pyrogallol and a catalytic amount of p-toluenesulfonic acid in a mortar and pestle. Calixarenes are sparingly soluble and high melting crystalline solids.

Calixarenes are characterised by a three-dimensional basket, cup or bucket shape. In calix[4]arenes, the internal volume is around 10 cubic nanometers. Calixarenes are characterised by a wide upper rim and a narrow lower rim and a central annulus. With phenol as a starting material the 4 hydroxyl groups are intrannular on the lower rim. In a resorcin[4]arene, 8 hydroxyl groups are placed extraannular on the upper ring. Calixarenes exist in different chemical conformations because rotation around the methylene bridge is not difficult. In calix[4]arene 4 up-down conformations exist: cone (point group C₂ᵥ,C₄ᵥ), partial cone Cₛ, 1,2 alternate C₂ₕ and 1,3 alternate D_{2d}. The 4 hydroxyl groups interact by hydrogen bonding and stabilize the cone conformation. This conformation is in dynamic equilibrium with the other conformations. Conformations can be locked in place with proper substituents replacing the hydroxyl groups which increase the rotational barrier. Alternatively placing a bulky substituent on the upper rim also locks a conformation. The calixarene based on p-tert-butyl phenol is also a cone.

Calixarenes are efficient sodium ionophores and are applied as such in chemical sensors. With the right chemistry these molecules exhibit great selectivity towards other cations. Calixarenes can be used as sodium selective electrodes for the measurement of sodium levels in blood. Calixarenes also form complexes with cadmium, lead, lanthanides and actinides. Calix[5]arene and the C₇₀ fullerene in p-xylene form a ball-and-socket supramolecular complex. Calixarenes also form exo-calix ammonium salts with aliphatic amines such as piperidine.

Molecular self-assembly of resorcinarenes and pyrogallolarenes lead to larger supramolecular assemblies. Both in the crystalline state and in solution, they are known to form hexamers that are akin to certain Archimedean solids with an internal volume of around one cubic nanometer (nanocapsules). (Isobutylpyrogallol[4]arene)₆ is held together by 48 intermolecular hydrogen bonds. The remaining 24 hydrogen bonds are intramolecular. The cavity is filled by a number of solvent molecules.

Calixarenes are applied in enzyme mimetics, ion sensitive electrodes or sensors, selective membranes, non-linear optics and in HPLC stationary phase. In addition, in nanotechnology calixarenes are used as negative resist for high-resolution electron beam lithography.

A tetrathia[4]arene is found to mimic aquaporin proteins. This calixarene adopts a 1,3-alternate conformation (methoxy groups populate the lower ring) and water is not contained in the basket but grabbed by two opposing tert-butyl groups on the outer rim in a pincer. The nonporous and hydrophobic crystals are soaked in water for 8 hours in which time the calixarene:water ratio nevertheless acquires the value of one. Calixarenes are able to accelerate reactions taking place inside the concavity by a combination of local concentration effect and polar stabilization of the transition state. An extended resorcin[4]arene cavitand is found to accelerate the reaction rate of a Menshutkin reaction between quinuclidine and butylbromide by a factor of 1600.

In heterocalixarenes the phenolic units are replaced by heterocycles, for instance by furans in calix[n]furanes and by pyridines in calix[n]pyridines. Calixarenes have been used as the macrocycle portion of a rotaxane and two calixarene molecules covalently joined together by the lower rims form carcerands.

U.S. Pat. No. 6,951,690 is entitled “Immobilized Calixarenes and Related Compounds and Process for Their Production” and discloses exemplary calixarenes that can be used to make micro particulate compositions according to this disclosure. The disclosure of this patent is incorporated herein by reference.

U.S. Pat. No. 5,717,126 is entitled “Phosphorous-containing calixarenes” and discloses exemplary calixarenes that can be used to make micro particulate compositions according to this disclosure. The disclosure of this patent is incorporated herein by reference.

For additional information regarding calixarenes, their manufacture, use and properties, reference is made to Gutsche, David C., Calixarenes: Synthesis and Historical Perspective, Encyclopedia of Supramolecular Chemistry (Aug. 17, 2004) (“Gutsche Article”), and also Khasnis, D. V. et al. Chemistry in Molecular Baskets: Variable Coordination of Phosphorus in Calix[4]arenes. Phosphorus, Sulfur, and Silicon, 1993, 75, 253-25, the disclosures of which are incorporated herein by reference.

In the Gutsche article, a simple method of forming a four member calixarene (2) from a phenolic molecule (1) is depicted as follows:

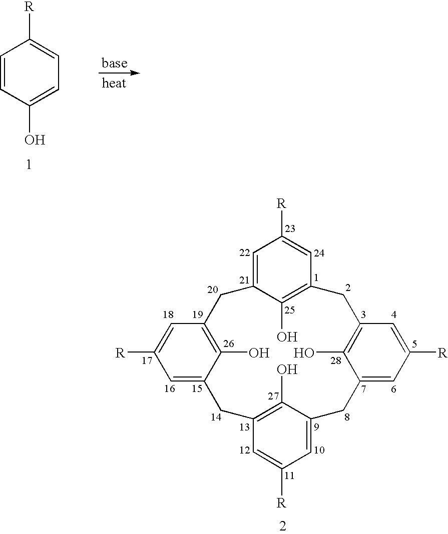

Five (3), six (4) and seven (5) member rings can also be made by this process, which have the following generic structures:

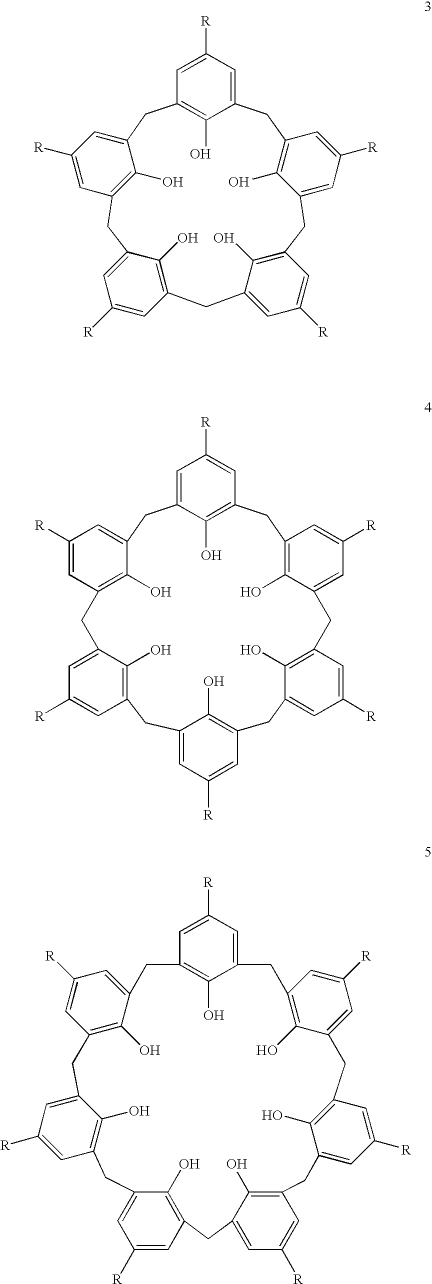

Example of calixarene crown ethers suitable for use as molecular baskets in selectively extracting metals in liquid or supercritical fluid solvents are disclosed in U.S. Publication No. 2008/0115627, entitled “Metal Extraction In Liquid Or Supercritical-Fluid Solvents, the disclosure of which is incorporated herein by reference.

2. Crown Ethers

Another class of exemplary molecular baskets is known as crown ethers. “Crown ethers” are heterocyclic chemical compounds that consist of a ring containing several ether groups. The most common crown ethers are oligomers of ethylene oxide, the repeating unit being ethyleneoxy, i.e., —CH₂CH₂O—. Important members of this series are the tetramer (n=4), the pentamer (n=5), and the hexamer (n=6). The term “crown” refers to the resemblance between the structure of a crown ether bound to a cation, and a crown sitting on a head. The first number in a crown ether's name refers to the number of atoms in the cycle, and the second number refers to the number of those atoms that are oxygen. Crown ethers are much broader than the oligomers of ethylene oxide; an important group are derived from catechol.

Crown ethers strongly bind certain cations, forming complexes. The oxygen atoms are well situated to coordinate with a cation located at the interior of the ring, whereas the exterior of the ring is hydrophobic. The resulting cations often form salts that are soluble in nonpolar solvents, and for this reason crown ethers are useful in phase transfer catalysis. The denticity of the polyether influences the affinity of the crown ether for various cations. For example, 18-crown-6 has high affinity for potassium cation, 15-crown-5 for sodium cation, and 12-crown-4 for lithium cation. The high affinity of 18-crown-6 for potassium ions contributes towards its toxicity. The following depict the structures of simple crown ether molecules, more particularly 12-crown-4, 15-crown-5, 18-crown-6, dibenzo-18-crown-6, and diaza-18-crown-6, respectively.

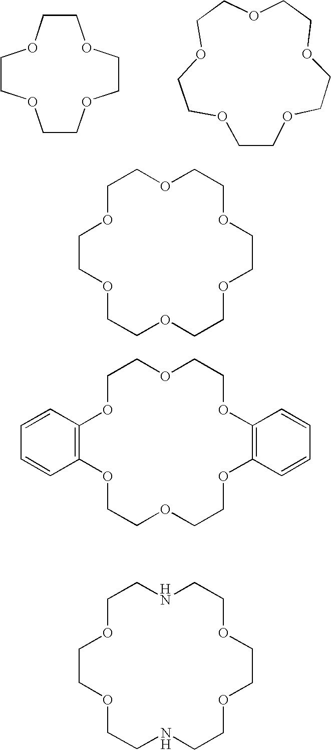

Apart from its high affinity for potassium cations, 18-crown-6 can also bind to protonated amines and form very stable complexes in both solution and the gas phase. Some amino acids, such as lysine, contain a primary amine on their side chains. Those protonated amino groups can bind to the cavity of 18-crown-6 and form stable complexes in the gas phase. Hydrogen-bonds are formed between the three hydrogen atoms of protonated amines and three oxygen atoms of 18-crown-6. These hydrogen-bonds make the complex a stable adduct.

“Aza-crowns” consist of crown ethers wherein an ether oxygen has been replaced by an amine group. A well-known tetrazacrown is cyclen. Mixed amine-ether crowns are also known. Because the aza hydrogen is acidic, aza crowns are proton-ionizable.

Synthetic crown ethers are not the only macrocyclic ligands that have affinity for the potassium cation. Ionophores such as nonactin and valinomycin also display a marked preference for the potassium cation over other cations.

Crown ethers can be derivatized to form thioethers in order to provide desired functionality. For example, a thiacrown molecular basket having high affinity for extracting silver but very poor affinity for alkali metals, is described in Liu, Q. S., et al., Thiacrown Molecular Basket with High Extraction Selectivity towards Ag⁺, Chinese Chemical Letters Vol. 17, No. 2, pp. 228-230, 2006, the disclosure of which is incorporated herein by reference. The thicrown ether described in this article includes a glycoluril-based host attached to a crown ether structure.

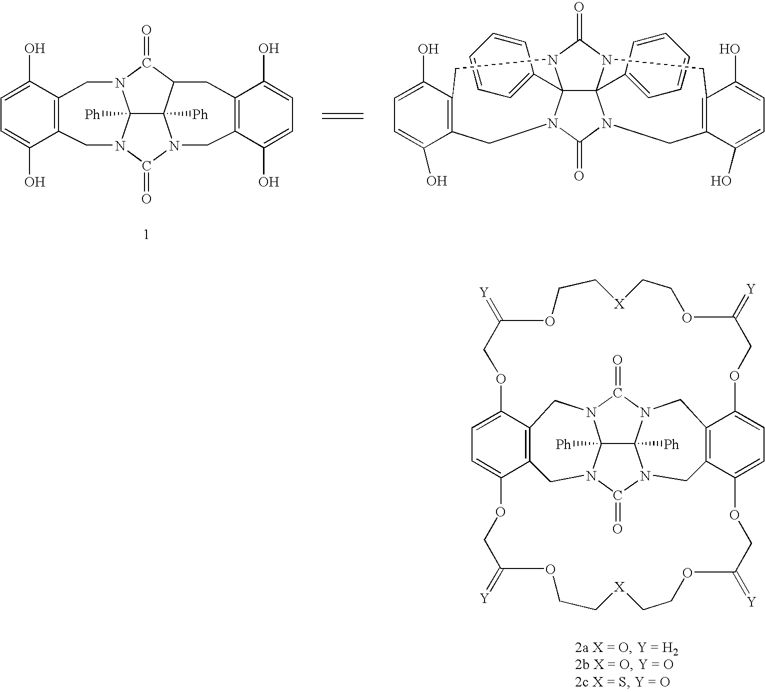

Additional information concerning glycoluril-based hosts and there use with crown ethers can be found in Elemans, J., et al., Glycoluril-Based Hosts, Encyclopedia of Supramolecular Chemistry, pp. 597-604, 2004, which is incorporated herein by reference. Glycoluril-based hosts have been studied for possible use as a host for small organic guests. The reaction of diphenylglycoluril (DPG) with formaldehyde in benzene yields a clip-shaped molecule. This molecule appears to have a rigid, U-shaped cavity and is an ideal host for dihydroxybenzene derivatives such as resorcinol and catechol. An enormous variety of glycoluril-based hosts possessing numerous functionalities have been synthesized. These hosts find application in many different research areas, such as mimics of biological systems, as amphophiles, and as liquid crystals. When the glycoluril-based hosts are incorporated within a crown ether, they form basket-shaped hosts that can bind to small organic molecules.

Another example of a crown ether is described in Li, Sheng-Hui, et al., Self-Assembly of Coordination Molecular Baskets as Inorganic Analogues of Cyclotriveratrylenes (CTV), Dalton Transactions, 2005, 2346-2348, the disclosure of which is incorporated by reference. This article describes self-assembling molecular baskets with novel crown-ether functionalized nano-cavities, which have potential as sensors for binding large cluster anions, such as cobalticarborane, polyoxometalate anions, etc or for multiple recognition of cations and anions.

The researchers of this article recently succeeded in the self-assembly of irregular metallo-organic container molecules with calixarene features, such as molecular bowls, crowns and capsules. They also developed a cavity-tunable modular self-assembly approach, which has provided a scafford for design and architecture of structurally and functionally new metallo-organic container molecules. In order to enlarge the cavity and modify the functionality of such metal-organic frameworks, they introduced the 1,10-phenanthroline-crown ethers ligand coordinated Pd(II) and Pt(II) complexes as building blocks to self-assemble with 4,7-phenanthroline (L) into basket-like contains molecules as shown below.

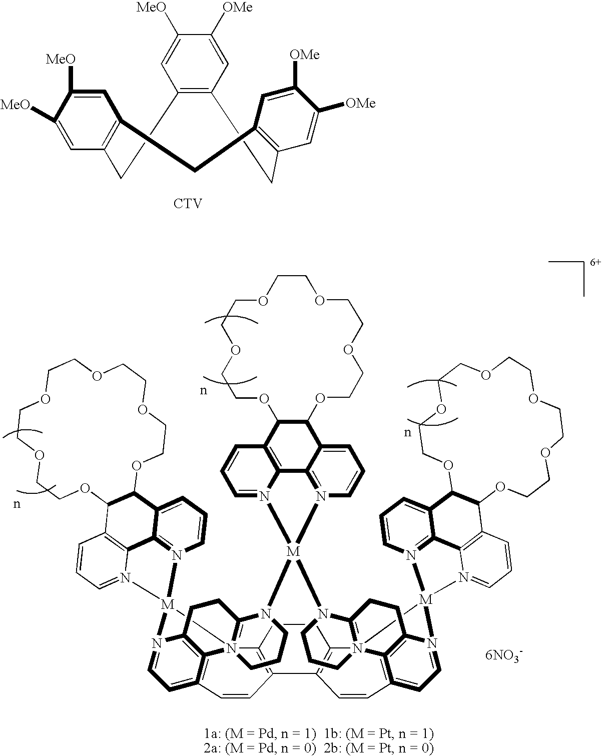

B. Examples of Micro Particles

Examples of micro particles that may be used to manufacture micro particulate compositions according to this disclosure includes, but are not limited to, melamine resin particles, poly(styrene) particles, poly(methyl methacrylate) particles, and silica particles, which are described in Monodisperse Nano- and Microparticles, Micro Particles GmbH Berlin, www.microparticles.de/properties.html. The melamine resin particles are described as having a density of 1.51 g/cm³, a refractive index of 1.68, excellent monodispersity (C.V.<3%) and highly uniform spherical shape, a hydrophilic surface, high cross-linking density, high temperature stability up to 300° C., superior mechanical strength, stability and insoluble in acids and bases, extremely stable in organic solvents, good long-term stability in dispersions, freeze-thaw stability in water, and available in sizes ranging from of 0.3 micron to 12 microns.

The poly(styrene) particles are described as having a density of 1.05 g/cm³, a refractive index of 1.59, high monodispersity and uniform spherical shape, a hydrophobic surface, having non-specific adsorption of proteins, low temperature resistance up to 100° C., soluble in organic solvents (dependent on degree of cross-linking), swellable in organic solvents, a coefficient of Variation (C.V. value) of <3% for research grade particles and for particle size standards, and available in sizes ranging from of 0.1 micron to 1000 microns.

The poly(methyl methacrylate) particles are described as having a density of a refractive index of 1.48, a hydrophobic anionic surface, individually tunable sizes of particles depending on the application, extremely narrow size distribution, excellent biocompatibility, good mechanical stability, soluble in organic solvents such as acetone, benzene or halogenated hydrocarbons, reduced non-specific protein binding activity, and available in sizes ranging from of 0.3 micron to 1000 microns.

The silica particles are described as having a density of 1.8-2 g/cm³, a refractive index of 1.42, a hydrophilic anionic surface, narrow size distribution, temperature resistance up to 1000° C., good mechanical stability, stable in organic solvents, soluble in strong bases and in hydrofluoric acid, and available in sizes ranging from of 0.15 micron to 8 microns.

Other examples of microparticles are disclosed in U.S. Publication No. 2008/0176340, which is entitled “Binding Surfaces for Affinity Assays”, the disclosure of which is incorporated herein by reference.

C. Manufacture of Micro Particle Compositions

Molecular baskets can be manufactured using any known method. Reagents, reactants and reaction conditions are selected in order to facilitate the assembly of the molecular framework of the molecular baskets, including any active bonding sites or other functional groups within the interior target receiving region. According to one embodiment, the molecular baskets are assembled using target molecules as a templating agent. This permits the molecular framework of the molecular baskets to have a size, conformation or other configuration that is particularly well-suited to selectively bond to the target molecule during use.

The molecular baskets are typically assembled in by dissolving or dispersing appropriate reagents or reactants in an appropriate solvent (e.g., water, lower alcohols such as methanol, ethanol, 1-propanol, and isopropyl alcohol, ketones, aldehydes, DMSO, DMF, tetrahydrofuran, ethyl acetate, and the like) and heating, mixing or introducing other appropriate inputs.

Once prepared, the molecular baskets can be isolated or purified using known techniques, including recrystallization, column chromatography, and the like. The purified molecular baskets may be attached to micro particles using known techniques for bonding or placing molecular baskets onto a support. According to one embodiment, molecular baskets are provided and applied to the micro particles in the form of a suspension or solution within a solvent. The molecular baskets may be dispersed onto outer surfaces and impregnated within interior pores of the micro particles. The molecular baskets can be bonded or attached to the micro particles by covalent bonding, ionic bonding, hydrogen bonding, Van der Waals forces, and the like.

According to one embodiment, the concentration of molecular baskets within a solution or suspension used to impregnate micro particles is in a range of about 1 ng/cm³ to about 1 g/cm³, expressed in terms of the mass of the molecular baskets per unit volume of the solution or suspension. In another embodiment, the concentration of molecular baskets within the solution or suspension is in a range of about 10 ng/cm³ to about 0.1 g/cm³. In yet another embodiment, the concentration of molecular baskets within the solution or suspension is in a range of about 100 ng/cm³ to about 0.01 g/cm³.

In terms of concentration by weight, the molecular baskets can have a concentration in a range of about 0.0001% to about 30% by weight of the solution or suspension, or about 0.01% to about 10% by weight, or about 0.1% to about 1% by weight.

Depending on the type of micro particles and molecular baskets that are utilized, they may already have an affinity for each other. In some cases it may be desirable to attach or create appropriate functional groups on the surface and within the pores of the micro particles to enhance bonding between the micro particles and molecular baskets. It other cases it may be desirable to functionalize the molecular baskets to have functional groups that complement surface functionality of the micro particles. In the case where the micro particles comprise silica, it may be desirable to attach silane groups to the molecular baskets in order to form a covalent bond with the micro particles. Alternatively, the molecular baskets may be attached to the micro particles by a condensation reaction (e.g., to form an ester, amide, ether, or the like).

D. Use of Micro Particle Compositions

The micro particulate compositions may be incorporated within or otherwise associated with an analytical device for use in detecting and/or separating of a target material in a sample. The micro particulate composition may be configured so as to facilitate contact between the micro particulate composition and a sample to be analyzed.

Micro particulate compositions may be used to detect and/or separate a target material in a sample. An exemplary method includes exposing the micro particulate composition to a sample containing a target material, wherein the micro particulate composition selectively binds to the target material. Micro particulate compositions as disclosed herein can be used to more accurately detect and/or separate target materials at higher throughput compared to conventional methods for utilizing molecular baskets. Molecular baskets supported on porous microparticles can be used in the following non-limiting examples of analytical and purification techniques: chromatographic assay, membrane separation, and absorption/adsorption column.

The molecular baskets can release the target material in response to an externally applied stimulus. Examples of external stimuli which may result in the release of targets from molecular baskets include exposure to photonic energy (e.g., of a particular wavelength), electrical energy (e.g., application of a particular voltage and/or current), a magnetic field (e.g., of a particular strength), specific pH, or a chemical concentration (e.g., of a salt). For example, exposure to a particular concentration of a given chemical may result in an oxidation-reduction reaction that alters the structural shape of the molecular basket, causing it to open or otherwise release the target.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A micro particulate composition comprising:
molecular baskets, each molecular basket having a molecular framework defining an exterior region and an interior target receiving region having a physical structure and/or chemical functionality for selectively receiving and binding a corresponding target material; and
porous micro particles onto which the molecular baskets are dispersed and impregnated, the micro particles having a high total surface area provided by external micro particle surfaces and internal pore surfaces.

2. A micro particulate composition as in claim 1, wherein the molecular baskets comprise at least one of calixarenes, crown ethers, or glycoluril-based hosts.

3. A micro particulate composition as in claim 1, wherein the molecular baskets have a concentration in a range of about 1 pg/cm³ to about 1 g/cm³ in terms of mass of molecular baskets per unit volume of the micro particulate composition

4. A micro particulate composition as in claim 1, wherein the molecular baskets have a concentration in a range of about 0.000001% to about 30% by weight of the micro particulate composition.

5. A micro particulate composition as in claim 1, wherein the microparticles comprise at least one of glass, silica, latex, polystyrene, carbon, silver, copper, or metal.

6. A micro particulate composition as in claim 1, wherein the microparticles have a specific surface area in a range of about 1 m²/kg to about 5,000,000 m²/kg.

7. A method for manufacturing a micro particulate composition comprising:
providing molecular baskets, each molecular basket having a molecular framework defining an exterior region and an interior target receiving region having one or more of a physical structure or a chemical functionality for one or more of selectively receiving or selectively binding a target material; and
dispersing the molecular baskets onto outer surfaces and within internal pores of porous micro particles.

8. A method as in claim 7, wherein the molecular baskets are provided as a solution or suspension within a solvent.

9. A method as in claim 8, wherein the molecular baskets have a concentration in a range of about 1 ng/cm³ to about 1 g/cm³ in terms of mass of the molecular baskets per unit volume of the solution or suspension.

10. A method as in claim 8, wherein the molecular baskets have a concentration in a range of about 0.0001% to about 30% by weight of the solution or suspension.

11. A method as in claim 7, wherein the molecular baskets have a concentration in a range of about 0.000001% to about 30% by weight of the micro particulate composition.

12. A method as in claim 7, the molecular baskets comprising at least one of calixarenes, crown ethers, or glycoluril-based hosts.

13. A method as in claim 7, the micro particles comprising at least one of glass, silica, latex, polystyrene, carbon, silver, copper, or metal.

14. A method as in claim 7, wherein the micro particles have high total surface area provided by external micro particle surfaces and internal pore surfaces.

15. A method as in claim 14, wherein the micro particles have a specific surface area in a range of about 1 m²/kg to about 5,000,000 m²/kg.

16. An analytical device for detection and/or separation of a target material in a sample, comprising:
a micro particulate composition that is comprised of:
molecular baskets, each molecular basket having a molecular framework defining an exterior region and an interior target receiving region having a physical structure and/or chemical functionality for selectively receiving and binding a corresponding target material; and
porous micro particles onto which the molecular baskets are dispersed and impregnated, the micro particles having a high total surface area provided by external micro particle surfaces and internal pore surfaces,
wherein the micro particulate composition is configured so as to facilitate contact between the micro particulate composition and a sample to be analyzed.

17. An analytical device as in claim 16, further comprising a vessel within which the micro particulate composition is at least partially contained.

18. An analytical device as in claim 16, wherein the vessel comprises a column, a tube, a probe, a reactor, or a membrane.

19. A method of using a micro particulate composition for detection and/or separation of a target material in a sample, the method comprising:
providing a micro particulate composition comprised of:
molecular baskets, each molecular basket having a molecular framework defining an exterior region and an interior target receiving region having a physical structure and/or chemical functionality for selectively receiving and binding a corresponding target material; and
porous micro particles onto which the molecular baskets are dispersed and impregnated;
exposing the micro particulate composition to a sample containing a target material; and
the micro particulate composition selectively binding to the target material.

20. A method as in claim 19, the target material comprising one or more of gaseous molecules or metal ions.

21. A method as in claim 19, the molecular baskets selectively binding to said target material at least in part due to chemical affinity between the interior target receiving region and the target material.

22. A method as in claim 19, the molecular baskets selectively binding to the target material at least in part due to size and/or structural affinity between the interior target receiving region and the target material.

23. A method as in claim 19, further comprising applying a stimulus to the micro particulate composition in order for the molecular baskets to selectively release the target material.
